(19) United States
(12) Patent Application Publication
(10) Pub. No.: US 2005/0061555 A1
(43) Pub. Date: Mar. 24, 2005

(54) Digital pointer indicator

(75) Inventors: Pin-Hsin Ho, Taichung (TW); Yu-Mei Chen, Dali City (TW)

Correspondence Address: CHARLES E. BAXLEY, ESQ., 90 JOHN STREET, THIRD FLOOR, NEW YORK, NY, 10038, US

(73) Assignee: Charder Electronic Co., Ltd.

(21) Appl. No.: 10/961,997

(22) Filed: Oct. 8, 2004

Related U.S. Application Data
(63) Continuation-in-part of application No. 10/357,770, filed on Feb. 4, 2003.

(51) Int. Cl. G01G 23/14; G06F 7/00; G06F 15/00

(52) U.S. Cl. 177/173

(57) ABSTRACT

A digital pointer indicator includes a signal output unit, a microprocessor unit, a digital display unit, and a pointer unit. The pointer unit includes a digital/analogue conversion control unit, a step motor, and a pointer. A thick film unit is connected between the digital/analogue conversion control unit of the pointer unit and the step motor, and it can provide pretty low impedance, so it is able to control a current of the digital/analogue conversion control unit precisely when the digital impulse signal is being transmitted, the rotation of the step motor is micro adjusted accordingly, and thus improving precision of the weight measurement.

### BACKGROUND OF THE INVENTION

1. Field of the Invention

The present invention relates to a weight indicator, and more particularly to a digital pointer indicator.

2. Description of the Related Art

Conventional weighing devices are generally divided into mechanical type (such as spring scale) and electronic type. Most of the weighing devices available on the market are provided both with a digital indicator and an analogue indicator (pointer indicator) for enabling the user to read the weight value more easily. For example, the weighing devices disclosed by U.S. Pat. Nos. 6,410,863, 6,689,964 and 6,608,260 are provided both with a digital indicator and a pointer indicator, however, this type weighing device still has some defects which are explained as follows:

The pointer indicator of this type weighing device measures the weight of an object by mechanical transmission method (such as the interaction of the gear cluster and the spring), when the object is weighed, the mechanical pointer will be caused to move relative to the display panel, and thus, the weight value is displayed. Meanwhile, the digital indicator will detect the mechanical motion of the mechanical pointer and display the weight value on the digital panel. Since the pointer indicator measures the weight of an object by mechanical transmission method, the weight value measured will not be very precise. As a result, the weight value indicated by the digital indicator is also not very precise.

### SUMMARY OF THE INVENTION

The present invention is to mitigate and/or obviate the disadvantage of the conventional weight measuring device.

The primary objective of the present invention is to provide a digital pointer indicator that not only can improve the precision of measurement but also can make the user read the weight value more easily.

In accordance with the present invention, there is provided a digital pointer indicator, comprising:

A digital pointer indicator comprises a signal output unit, a microprocessor unit, a digital display unit, and a pointer unit, wherein:
the signal output unit outputs an electronic signal according to a weight of an object to be measured;
the microprocessor unit is connected to the signal output unit, the microprocessor unit converts the electronic signal output from the signal output unit into a digital signal, and outputs the digital signal;
the digital display unit is connected to the microprocessor unit, the digital display unit converts the digital signal output from the microprocessor unit into a value, and indicates the value; and
the pointer unit includes a digital/analogue conversion control unit, a step motor, and a pointer, the digital/analogue conversion control unit is connected to the microprocessor unit, the digital/analogue conversion control unit converts the digital signal output from the microprocessor unit into a digital impulse signal and transmits the digital impulse signal to the step motor, so as to make the step motor drive the pointer to move;
a thick film unit is connected between the digital/analogue conversion control unit of the pointer unit and the step motor, the thick film unit can provide low impedance, so it is able to control a current of the digital/analogue conversion control unit precisely when the digital impulse signal is being transmitted, the rotation of the step motor is micro adjusted accordingly, and thus improving precision of the weight measurement.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a digital pointer indicator in accordance with the preferred of the present invention;

FIG. 2 is a schematic structural view of the digital pointer indicator in accordance with the preferred of the present invention;

FIG. 3 is a schematic plan operational view of the digital type pointer indicator in accordance with the preferred of the present invention.

### DETAILED DESCRIPTION OF THE INVENTION

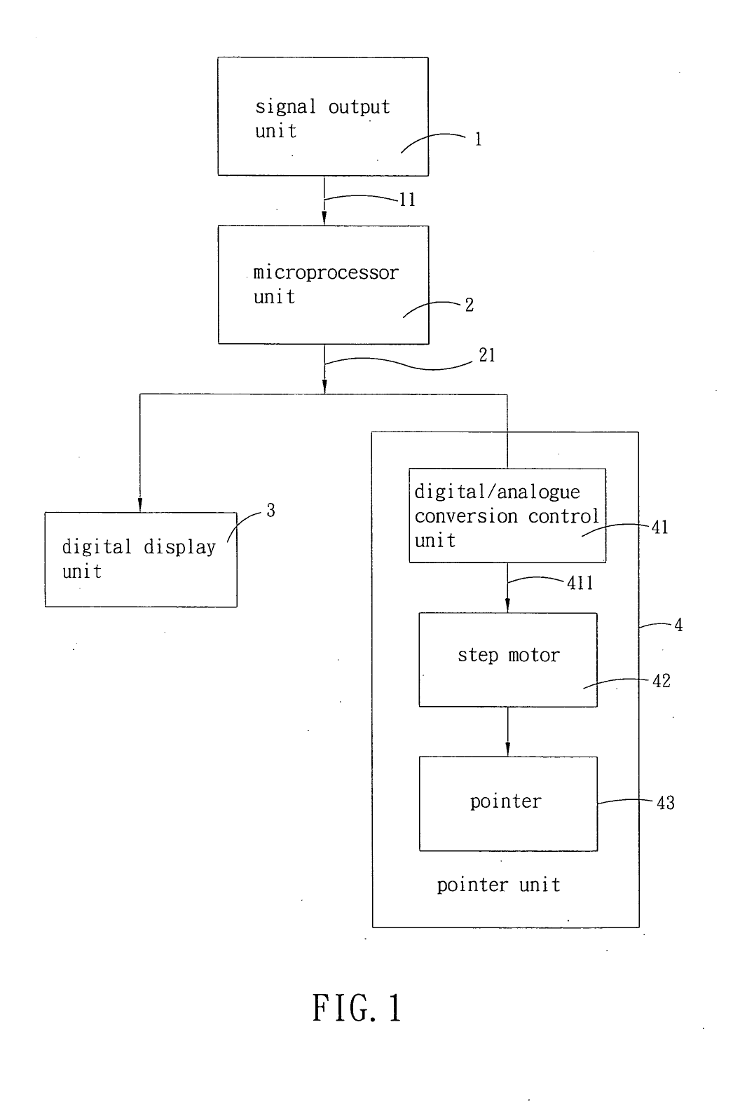

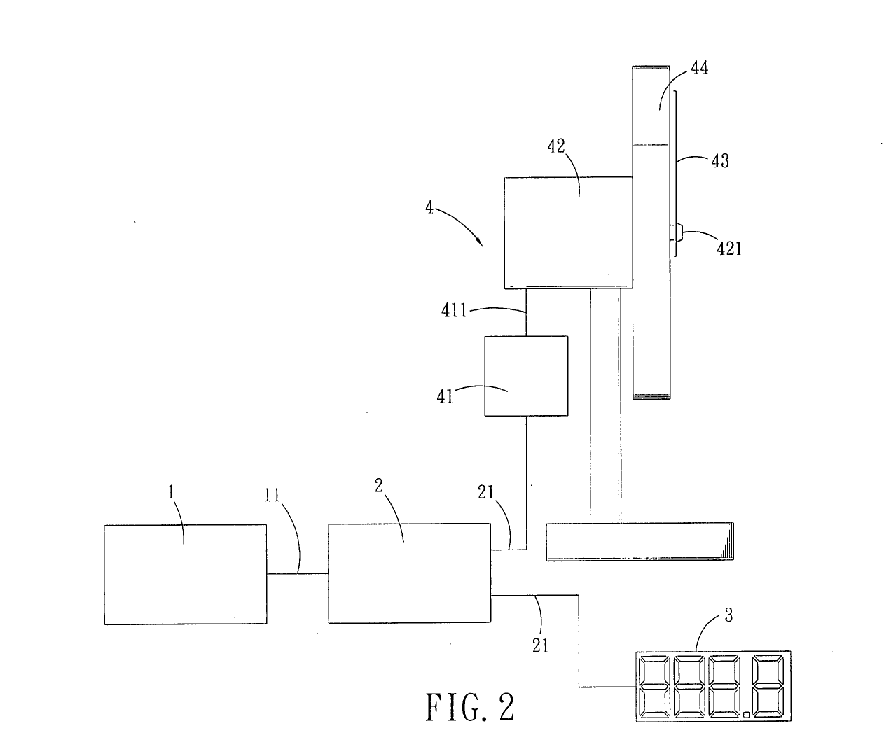

Referring to the drawings and initially to FIGS. 1 and 2, a digital pointer indicator in accordance with the preferred embodiment of the present invention comprises a signal output unit 1, a microprocessor unit 2, a digital display unit 3, and a pointer unit 4 and a thick film unit 5.

The signal output unit 1 is an externally connected signal output unit. The signal output unit 1 has an inside provided with a bearing load member (not shown) that is required for measuring the weight of the object to be measured. Thus, when the object to be measured is placed on the signal output unit 1, the signal output unit 1 outputs an electronic signal 11 by detection of the bearing load member. The electronic signal 11 is varied according to the weights of the different objects to be measured.

The microprocessor unit 2 is connected to the signal output unit 1. The microprocessor unit 2 converts the electronic signal 11 output from the signal output 10 unit 1 into a digital signal 21, and outputs the digital signal 21.

The digital display unit 3 is connected to the microprocessor unit 2. The digital display unit 3 converts the digital signal 21 output from the microprocessor unit 2 into a value, and indicates the value.

The pointer unit 4 includes a digital/analogue conversion control unit 41, a step motor 42, and a pointer 43. The digital/analogue conversion control unit 41 of the pointer unit 4 is connected to the microprocessor unit 2. The digital/analogue conversion control unit 41 of the pointer unit 4 converts the digital signal 21 output from the microprocessor unit 2 into a digital impulse signal 411 and transmits the digital impulse signal 411 to the step motor 42, so that the step motor 42 will drive the pointer 43 to move on the a scale panel 44.

The step motor 42 of the pointer unit 4 is connected to the digital/analogue conversion control unit 41, and is mounted on a scale panel 44. The step motor 42 of the pointer unit 4 has a rotation shaft 421 protruding outward from a center of the scale panel 44. Preferably, the scale panel 44 has a circular shape. In operation, the step motor 42 of the pointer unit 4 receives the digital impulse signal 411 output from the digital/analogue conversion control unit 41. Thus, the step motor 42 of the pointer unit 4 is driven by the digital impulse signal 411 output from the digital/analogue conversion control unit 41, so that the rotation shaft 421 of the step motor 42 is rotated through a fixed angle.

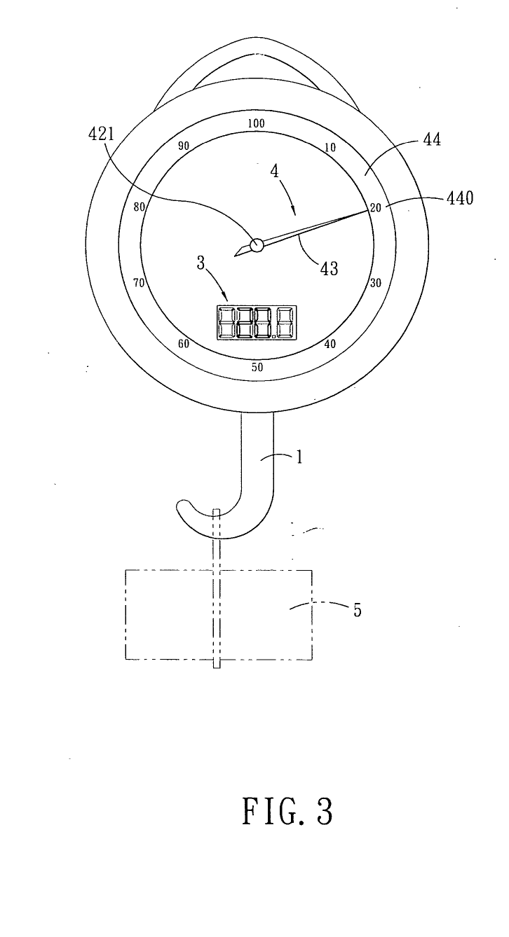

The pointer 43 of the pointer unit 4 has a first end secured on the rotation shaft 421 of the step motor 42 to rotate therewith and a second end directed toward the scale 440 (see FIG. 3) on the scale panel 44. In addition, the pointer 43 of the pointer unit 4 is moved according to the fixed angle of the rotation shaft 421 of the step motor 42.

In practice, when the object to be measured is placed on the signal output unit 1, the signal output unit 1 outputs an electronic signal 11 by detection of the bearing load member. Then, the microprocessor unit 2 converts the electronic signal 11 output from the signal output unit 1 into a digital signal 21, and outputs the digital signal 21. Then, the digital signal 21 output from the microprocessor unit 2 is transmitted to the digital display unit 3 and the pointer unit 4 respectively. At this time, the digital display unit 3 converts the digital signal 21 output from the microprocessor unit 2 into a value, and indicates the value transferred from the digital signal 21, wherein the indicated value is the weight of the object to be measured. At the same time, the pointer 43 of the pointer unit 4 is pointed to the value of the scale 440 (see FIG. 3) on the scale panel 44, wherein the value is the weight of the object to be measured. In addition, the value of the scale 440 (see FIG. 3) on the scale panel 44 pointed by the pointer 43 of the pointer unit 4 is exactly the value indicated on the digital display unit 3.

Thus, the digital pointer indicator in accordance with the present invention can indicate the weight of the object to be measured by the digital display unit 3 and by the pointer 43 of the pointer unit 4.

For example, as shown in FIG. 3, after the object 5 to be measured is placed on the signal output unit 1, the signal output unit 1 outputs an electronic signal 11 that is processed by the microprocessor unit 2 which converts the electronic signal 11 into a digital signal 21, and outputs the digital signal 21 to the digital display unit 3 and the pointer unit 4 respectively. Thus, the value representing the weight of the object 5 is indicated on the digital display unit 3, and is pointed by the pointer 43 of the pointer unit 4 on the scale 440 of the scale panel 44.

Accordingly, the user can doubly read the weight of the object 5 to be measured through the digital display unit 3 and through the pointer 43 of the pointer unit 4, thereby facilitating the user identifying the value of the weight of the object 5, and thereby preventing the user from misunderstanding the value of the weight of the object 5.

In addition, in the digital pointer indicator in accordance with the present invention, the digital/analogue conversion control unit 41 of the pointer unit 4 converts the digital signal 21 output from the microprocessor unit 2 into a digital impulse signal 411 and outputs the digital impulse signal 411. The magnitude of the digital signal 21 is determined according to the weight of the object 5. Thus, the digital impulse signal 411 output from the digital/analogue conversion control unit 41 of the pointer unit 4 is very exact, so that the rotation shaft 421 of the step motor 42 is operated and rotated exactly and precisely, thereby enhancing the precision of the pointer 43 of the pointer unit 4 on the scale 440 of the scale panel 44, so as to point the weight of the object 5 exactly.

The thick film unit 5 is connected between the digital/analogue conversion control unit 41 of the pointer unit 4 and the step motor 42. Since the thick film unit 5 can provide pretty low impedance, it is able to control the current of the digital/analogue conversion control unit 41 precisely when the digital impulse signal 411 is being transmitted. Thus, the rotation of the step motor 42 can be micro adjusted, and the pointer 43 driven by the step motor 42 is able to display the weight value precisely. Thereby, besides the digital unit 3 and the pointer 4 display the weight value of an object synchronously in both analogue and digital ways, so as to make the user read it easily and conveniently, the digital pointer indicator further can display the weight value very precisely.

While the preferred embodiment(s) of the present invention has been shown and described, it will be apparent to those skilled in the art that various modifications may be made in the embodiment(s) without departing from the spirit of the present invention. Such modifications are all within the scope of the present invention.

1. A digital pointer indicator, comprising a signal output unit, a microprocessor unit, a digital display unit, and a pointer unit, wherein:
the signal output unit outputs an electronic signal according to a weight of an object to be measured;
the microprocessor unit is connected to the signal output unit, the microprocessor unit converts the electronic signal output from the signal output unit into a digital signal, and outputs the digital signal;
the digital display unit is connected to the microprocessor unit, the digital display unit converts the digital signal output from the microprocessor unit into a value, and indicates the value; and
the pointer unit includes a digital/analogue conversion control unit, a step motor, and a pointer, the digital/analogue conversion control unit is connected to the microprocessor unit, the digital/analogue conversion control unit converts the digital signal output from the microprocessor unit into a digital impulse signal and transmits the digital impulse signal to the step motor, so as to make the step motor drive the pointer to move;
a thick film unit is connected between the digital/analogue conversion control unit of the pointer unit and the step motor, the thick film unit can provide a low impedance, so it is able to control a current of the digital/analogue conversion control unit precisely when the digital impulse signal is being transmitted, the rotation of the step motor is micro adjusted accordingly, and thus improving precision of the weight measurement.
